(19) United States
(12) Patent Application Publication
(10) Pub. No.: US 2021/0279578 A1
(43) Pub. Date: Sep. 9, 2021

(54) Elevator Maintenance Solution Leveraging IOT Data, Cloud-Based Predictive Analytics and Machine Learning

(71) Applicant: Datahoist, Inc., Austin, TX (US)

(72) Inventor: Dan Bryant, Elgin, TX (US)

(21) Appl. No.: 17/258,151

(22) PCT Filed: Jul. 5, 2019
(86) PCT No.: PCT/US2019/040745

§ 371 Date: Jan. 5, 2021

Related U.S. Application Data
(60) Provisional application No. 62/694,435, filed on Jul. 5, 2018.

(51) Int. Cl. G06N 3/08; G06N 3/04; B66B 5/00; B66B 3/00; B66B 1/34; B66B 13/22

(52) U.S. Cl. CPC G06N 3/08; G06N 3/0445; B66B 13/22; B66B 3/002; B66B 1/3492; B66B 5/0025

(57) ABSTRACT

A system for monitoring an elevator is provided. The system includes an edge intelligence module which includes an edge device installed on an elevator, a sensor package which includes at least one accelerometer and which captures motion-related operational data, and a neural network; a data aggregation module which aggregates data from said edge intelligence module; an intelligence and analysis module which receives data from said data aggregation module and processes said data to generate notifications and to perform data analytics; and a presentation module generates a web-based user interface, wherein said user interface includes at least one dashboard and a platform for accessing the notifications generated by the cloud intelligence and analysis module.

### CROSS-REFERENCE TO RELATED APPLICATIONS

This application claims the benefit of U.S. Provisional Application No. 62/694,435, filed Jul. 5, 2019, which has the same title and inventor, and which is incorporated herein by reference in its entirety.

### FIELD OF THE DISCLOSURE

The present application relates generally to systems for elevator maintenance, and more specifically to such systems which leverage IoT data, cloud-based learning and predictive analytics.

### BACKGROUND OF THE DISCLOSURE

Elevator maintenance activities have followed the same process for decades. Companies purchase assets and, after placing them into service, set up maintenance intervals based on cycles. The assets are then repaired or replaced when broken.

Most maintenance service performed in the industry may be characterized as reactive or preventive maintenance. Although preventive maintenance is ideal, it relies on accurate, efficient, and cost-effective monitoring solutions that can incorporate data feeds from elevator components.

At present, there are at least 13 million elevator units worldwide, including about one million in the U.S. alone. However, only about 0.5% of these elevators are currently serviced by IoT solutions. In fact, IoT is not widely used in the industry, which is slow to move on development. However, there is a significant push towards automating solutions, given the high costs of elevator maintenance. The need for such automation is further driven by the fact that 30% of skilled elevator workers in the U.S. will be retiring in the next five years, and new elevator technicians typically lack the knowledge and expertise required to operate manual solutions.

### BRIEF DESCRIPTION OF THE DRAWINGS

FIG. 1 is an illustration of a system for monitoring an elevator.

FIG. 2 is an illustration of an architecture for the system of FIG. 1.

FIG. 3 depicts the acceleration curve for an elevator carriage as it completes a duty cycle starting at the 3^{rd} floor of a building and ending in the basement.

FIG. 4 depicts the acceleration curves related to door operations for a Delta VFD-M-D series elevator.

### SUMMARY OF THE DISCLOSURE

In one aspect, a system for monitoring an elevator is provided. The system comprises an edge intelligence module which includes an edge device installed on an elevator, a sensor package which includes at least one accelerometer and which captures motion-related operational data, and a neural network; a data aggregation module which aggregates data from said edge intelligence module; an intelligence and analysis module which receives data from said data aggregation module and processes said data to generate notifications and to perform data analytics; and a presentation module generates a web-based user interface, wherein said user interface includes at least one dashboard and a platform for accessing the notifications generated by the cloud intelligence and analysis module.

In another aspect, a method for monitoring the operational status of an elevator is provided. The method comprises installing a sensor package on the elevator, the sensor package including at least one accelerometer; collecting a first set of operational data from the sensor package, wherein the first set of operational data includes motion-related sensor data generated by the sensor package as the elevator progresses through duty cycles while the elevator is in a proper working condition; training a neural network on the first set of operational data, thereby obtaining a trained neural network; collecting a second set of operational data from the sensor package, wherein the second set of operational data includes motion-related sensor data generated by the sensor package as the elevator progresses through duty cycles; analyzing the second set of operational data with the trained neural network to generate a set of analytical results related to the current state of the elevator; and displaying the set of analytical results on a display.

### DETAILED DESCRIPTION

Elevator maintenance is beset by several challenges. One of these challenges is the high maintenance costs that are typically associated with these assets. Consequently, customers in the industry are typically caught in a cycle of elevator maintenance that is both costly and complex. Costs may be reduced by proactive maintenance. However, this typically requires maintenance contracts and servicing on a regular schedule. Even then, emergencies may arise which require unscheduled repairs and callbacks, and which drive up costs even more.

Another challenge relates to the lack of collection data. Shifting from a “reactive” to a “proactive” maintenance paradigm requires more proactive monitoring than is available with routine servicing. This is especially true with an aging elevator maintenance workforce. Although various monitoring systems are known to the art, at present, no solutions exist that collect data across disparate elevator types.

A further challenge relates to the limited solution choice available in the marketplace. Currently, the few proactive management solutions that exist are provided by OEMs. However, these solutions lock customers into proprietary solutions, may be extremely costly, are limited to elevators having particular configurations and features, and often do not work on older elevators.

Some or all of the foregoing issues may be addressed with the systems and methodologies described herein. In a preferred embodiment, a cloud-based monitoring solution is provided that leverages features possessed by any elevator, and that allows building owners and service organizations to transition maintenance activities from outdated reactive and preventive maintenance strategies to proactive, condition-based, and predictive maintenance strategies. The monitoring solution may be utilized on any elevator, for any service provider, and for any facilities manager. It may be utilized to monitor the health of all of the elevators in a facility, simplify elevator maintenance with 24/7 monitoring, and lower elevator maintenance costs with predictive analytics. Use of the monitoring solution allows facility maintenance staff to monitor the health of all of the elevators, simplify how the elevators are maintained, and use predictive analytics to lower maintenance costs even further in the future.

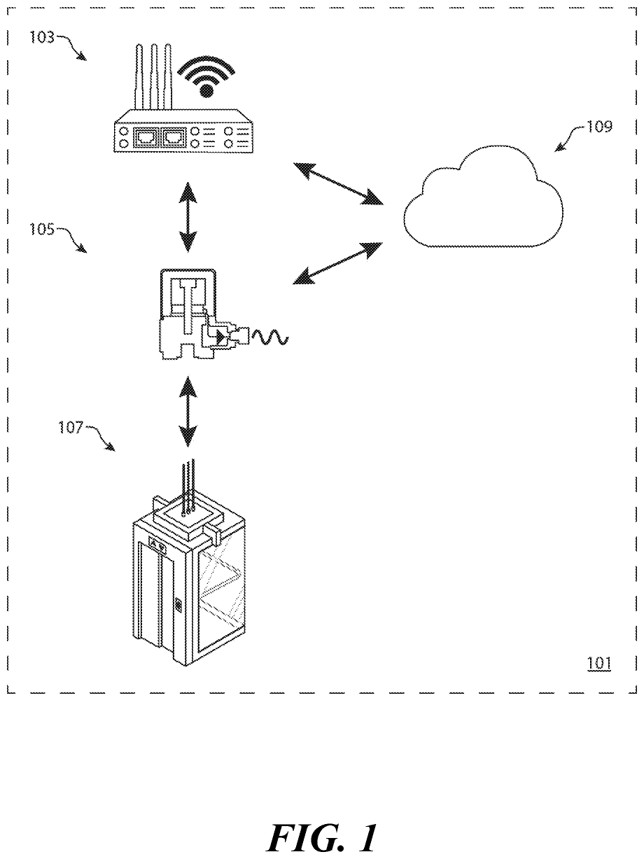

FIG. 1 depicts a particular, non-limiting embodiment of a monitoring solution in accordance with the teachings herein. This system 101 gathers and processes elevator data using IoT devices combined with adaptive, self-learning algorithms. Sensors 105 are deployed on the cartop of an elevator 107 (and typically in the doors as well) and send data (typically through the use of appropriate wireless technology) through an edge gateway 103 into a cloud computing platform 109, where data is processed and analyzed. The monitoring solution may be deployed as a solution that is fast and easy to install, and which learns patterns and alerts users to any anomalies it detects.

Various cloud computing platforms and solutions may be utilized with the monitoring solution depicted in FIG. 1. The use of Microsoft Azure is preferred. However, other cloud computing platforms which may be utilized with this monitoring system include, but are not limited to, Amazon Web Services, the Google Cloud Platform, IBM Cloud, Alibaba Cloud, VMware Cloud Foundation, and the AlertLogic security platform.

The monitoring solution disclosed herein provides a fast, simple means for monitoring the overall health of elevators in real-time. It may be utilized with any elevator, regardless of age or manufacturer. In a preferred embodiment, the monitoring solution includes at least one cartop sensor and at least one door sensor equipped with inputs for signal monitoring of data. These sensors may be utilized to provide the user with full details on the health of elevators, including elevator state information, acceleration details, and door information. Moreover, because the monitoring solution may be readily installed on any elevator equipment (typically in less than an hour) and utilizes parameters (such as, for example, acceleration or power) that may be leverages to characterize the state of any elevator, the user is not locked into proprietary OEM systems. Hence, the user is not required to purchase a new elevator in order to obtain full IoT capabilities, or to add features or capabilities to the elevator in order to support the monitoring solution.

The monitoring solution disclosed herein may be configured to provide comprehensive elevator usage data in real time, across all of the elevators in a facility. Accordingly, the user may be provided with instant notifications any time there are changes in how the elevator is running, thus allowing maintenance crews to stay on top of the health of the elevator and to ensure safety. Moreover, data processing may be distributed throughout the system, thus minimizing bandwidth usage and reducing cloud and wireless communications costs.

The monitoring solution disclosed herein may be utilized to dramatically lower elevator maintenance costs by automating the monitoring process and turning data into predictive analytics. As previously noted, in its preferred embodiment, the monitoring solution is based on the Microsoft Azure platform. The use of such a cloud computing platform allows a user to readily leverage data analytics and machine learning to pinpoint potential issues before they become problems. The data analytics and machine learning may be based on various algorithms and analytics available through dashboards, notifications, menus, pages, and other suitable provisions, and may feature health trends for both the elevator as a whole and specific components thereof (such as, for example, the doors and the car).

In a preferred embodiment, the monitoring solution is adapted to integrate with other platforms and software, thus providing additional analytics layers for deeper insights, machine learning, and ease of integration. It may be deployed as a readily scalable solution across single or multiple locations.

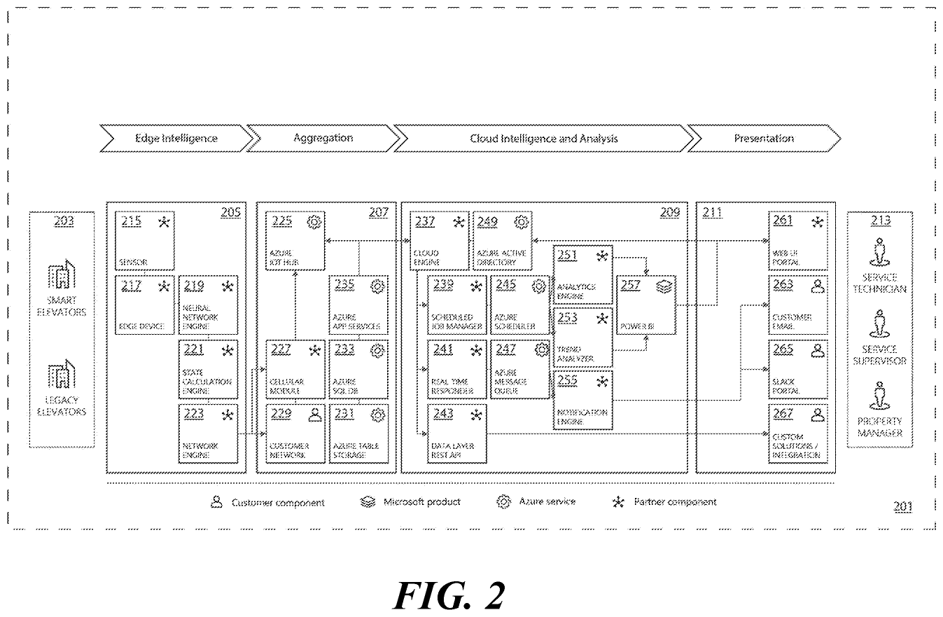

FIG. 2 is an illustration of a particular, non-limiting embodiment of a system architecture for a monitoring solution in accordance with the teachings herein. With reference thereto, the system architecture 201 provides an interface between a set of elevators 203 (which may include both smart elevators and legacy elevators) and a maintenance crew 213 (which may include service technicians, service supervisors and property managers). Functionally speaking, the architecture 201 consists of an edge intelligence module 205, a data aggregation module 207, a cloud intelligence and analysis module 209 and a data presentation module 211. Of course, it will be appreciated that, in a specific embodiment or implementation, these modules, and their various components, functionalities and subsystems, may not be segregated in the specific manner depicted in FIG. 2, but may be intermingled or combined in various manners.

In the particular embodiment depicted in FIG. 2, the edge intelligence module 205 includes sensors 215, edge devices 217, a neural network engine 219, a state calculation engine 221 and a network engine 223. The edge device 217 in the edge intelligence module 205 provide built-in machine learning (via neural network engine 219) and state calculation logic (via state calculation engine 221), thus allowing the system to go well beyond simple data collection.

The neural network engine 219 may implement various types of machine learning algorithms. These include, for example, reinforcement learning algorithms and supervised, unsupervised or semi-supervised learning algorithms. Specific algorithms implemented by the neural network engine 219 may include, but are not limited to, nearest neighbor algorithms, naïve Bayes algorithms, decision trees, predictive analytics (including, for example, those based on linear regression), support vector machines (SVMs), clustering or grouping algorithms (including, for example, k-means clustering algorithms), association rules, Q-learning, deep adversarial networks, and temporal difference algorithms.

In some embodiments, the neural network engine 219 may feature a stacked neural network in which each layer in the neural network includes a plurality of nodes that apply weights or coefficients to input from data, thus amplifying or dampening the input. Such a stacked neural network may be utilized to implement deep learning concepts and algorithms. In some embodiments, the neural network engine 219 may implement recurrent neural networks (RNNs).

The use of RNNs having long short-term memory (LSTM) architectures is especially preferred. An RNN utilized in the systems and methodologies disclosed herein and having an LSTM architecture preferably includes a cell, an input gate, an output gate and a forget gate, and is thus well-suited to processing, classifying and making predictions based on the type of time series data that is preferably collected in the systems and methodologies disclosed herein.

In the particular embodiment depicted in FIG. 2, the data aggregation module 207 includes an Azure IoT hub 225, a cellular module 227, a customer network 229, an Azure table storage 231, an Azure SQL database 233, and Azure application services 235. The Azure table storage 231, an Azure SQL database 233, and Azure application services 235 are in communication with ach other. The cellular module 227 and customer network 229 are in communication with the network engine 223 of the edge intelligence module 205. The Azure application services 235 run on the edge devices 217 to collect sensor data therefrom. The Azure SQL database 233 collects and stores data in a relational database. The Azure table storage 231 collects and stores sensor data in tables. The Azure IoT hub 225 is in communication with the Azure cloud engine 237 in the cloud intelligence and analysis module 209. In operation, the Azure IoT hub 225 serves to collect sensor data from the edge devices 217, which sensor data may then be sent to the Azure cloud engine 237. The data aggregation module 207 allows data to be transferred to the secure Azure cloud for processing via either the customer network 229 or the cellular module 227.

In the particular embodiment depicted in FIG. 2, the cloud intelligence and analysis module 209 includes the aforementioned cloud engine 237, which is in communication with an Azure active directory 249, a scheduled job manager 239, a real-time responder 241 and a data layer REST API 243. The scheduled job manager 239 is in communication with an Azure scheduler 245, and the real-time responder 241 is in communication with an Azure message queue 247. The Azure scheduler 245 is in communication with an analytics engine 251 and a trend analyzer 253, and the Azure message queue is in communication with a notification engine 255. The analytics engine 251 and trend analyzer 253 are in communication with a Power BI 257, the latter of which is a suite of business analytics tools adapted to analyze data and share insights.

The Azure active directory 249 enables web user interface (UI) portal logins by integrating with user identities. The Azure scheduler 245 creates jobs from sensor data to be sent to the analytics engine and trend analyzer. The Azure message queue 247 routes messages to the notification engine 255.

The cloud intelligence and analysis module 209 brings data together using the cloud engine 237 for processing. Such processing may occur via the real-time responder 241 that drives notifications, or via the scheduled job manager 239 that runs trends and data analytics while the separate data layer API 243 also allows for custom solutions and integrations.

In the particular embodiment depicted in FIG. 2, the presentation module 209 includes a web user interface (UI) portal 261, a customer email directory 263, a slack portal 265 and a customer solutions/integration component 267. The web UI portal 261 is in communication with the power BI 257 and Azure active directory 249 of the cloud intelligence and analysis module 209. Similarly, the customer email directory 263 and slack portal 265 are in communication with the notification engine 255, and the customer solutions/integration component 267 is in communication with the data layer REST API 243. The presentation module 209 provides access to dashboards, data and notifications via multiple applications or with custom solutions/integrations 267.

It will be appreciated from the embodiment of the system architecture depicted in FIG. 2 that the Azure platform utilized in the preferred embodiment of the elevator monitoring solution disclosed herein is highly advantageous for a multitude of reasons. It enables true productivity when it comes to elevator maintenance because there is seamless integration between the sensors, the edge devices and the cloud. For instance, it allows much of the analytics themselves to be pushed out to the edge device. Consequently, this data is instantly available, and gathering the data is more cost-effective. Moreover, this data enables various business apps, and may be used in a wide variety of applications to transform how elevator companies look at data and intelligence. In addition, the security inherent in the Azure platform offers significant protection against intrusions and helps to minimize vulnerabilities.

In a typical implementation of a system of the type described herein, the monitoring solution is attached to an elevator which is in proper working condition. The monitoring solution is preferably attached to the power source of the host elevator, though in some embodiments, the monitoring solution may be equipped with battery power which operates in place of, in conjunction with, or as a backup to, the host power source. The accelerometer (or accelerometers) and other sensors in the monitoring solution begin collecting operational data (and preferably, motion-related data such as, for example, the acceleration of the carriage at a particular point in the duty cycle, or vibration peaks associated with motion of the carriage or doors at particular points in the duty cycle), and the monitoring solution applies machine learning to this operational data.

The monitoring solution quickly learns the normal motion characteristics of the elevator at particular points in its duty cycle (that is, it learns what the operational data of the elevator looks like when the elevator is in a healthy operational state). These characteristics may include, for example, the maximum acceleration of the elevator as it moves from the ground floor of a building and stops at the third floor of the building, the average length of time required for the doors to open or close, or the peak vibrations as the doors are opening or closing.

The monitoring solution then applies statistical and predictive analytics to the operational data to detect the onset of problems, to predict maintenance cycles, or to perform other useful functions. For example, the monitoring solution might detect the presence of non-zero acceleration values in the middle of a long run, which may indicate the onset of a mechanical issue with the elevator. As a further example, the monitoring solution may detect a statistically significant shift in the mean door opening or door closing time, which may suggest that the doors need to be examined during the next scheduled maintenance event. The monitoring solution may also predict the mean time to failure for various components in the elevator, based on the operational data.

In a preferred embodiment of the systems and methodologies described herein, all of the operational data that is gathered is obtained (or derived) from one or more accelerometers. For example, although the actual location of the elevator is not necessarily known, based on known parameters of elevators and the initial learning it has undertaken, the monitoring solution knows where the elevator is at any moment on an acceleration curve. Consequently, using predictive analytics, the monitoring solution is able to predict where the elevator will be on an acceleration curve.

Data from door operation is received through discrete inputs, and the door operation is learned by using processed acceleration data to know when the elevator carriage is at rest. A machine learning algorithm is then utilized to go through the various door switch states as the doors open and close at each floor (there are typically 2 to 5 such switch states). Once learned, a baseline is set, and another algorithm is used to register higher level door events. These are aggregated at periodic intervals (preferably hourly) and compared against the baseline. One or more accelerometers are used to measure vibration during door operations, and the resulting data is used for trend analytics.

The preferred machine algorithms utilized in the systems and methodologies described herein employ an LSTM neural network. These operations may be deployed to edge compute devices using TensorFlow, an end-to-end open source platform for machine learning. TensorFlow has a comprehensive, flexible ecosystem of tools, libraries and community resources for machine learning, and facilitates the building and deployment of machine learning applications.

The LSTM model may be utilized (sometimes in combination with the knowledge that the state of the input is on or off) by remembering when an operation started. A debouncing operation is applied to the discrete inputs picked up by the monitoring solution. It has been found that, even by employing standard debouncing algorithms, events may still be missed and, even if all events are captured, the timing of the events may not be exact. Exact timing (often in milliseconds, but sometimes in microseconds) is not typically important for the monitoring solution, since it is preferred that the monitoring solution not act on an input until a certain time passes to make sure that state is indeed changed. On the other hand, in monitoring, troubleshooting and machine learning, it is often critical that the exact timing is known. To address the foregoing issues, an LSTM model is employed to know (a) the exact time the switch was changed, and (b) the fact that the switch has indeed changed. Hence, in preferred embodiments of the systems and methodologies described herein, the LSTM model is used even on the debouncing operation.

Various switch states may be employed in the systems and methodologies described herein. For example, with respect to door operations, these switch states may include, but are not limited to, door opening (which may include the states of the door starting to open, the outside door starting to open, and the door being fully open), door closing, and interlocked states. These switch states may vary from elevator type to elevator type, and the way the switch states are detected by the input/output (IO) channels in a microcontroller unit (MCU) may vary even between the same types of elevators in different installations. For this reason, it is desirable to first learn what the states mean before commencing the analytical process of knowing the elevator operation at a higher level of event type.

In some applications, the foregoing logic signal analytics may be utilized in motor control operations where the brake pick and drop, in relation to power being applied and taken away, is the same as the door switches in the logic signal analytics described herein. In such applications, an accelerometer may be utilized to recognize the difference between motion and rest as is described herein.

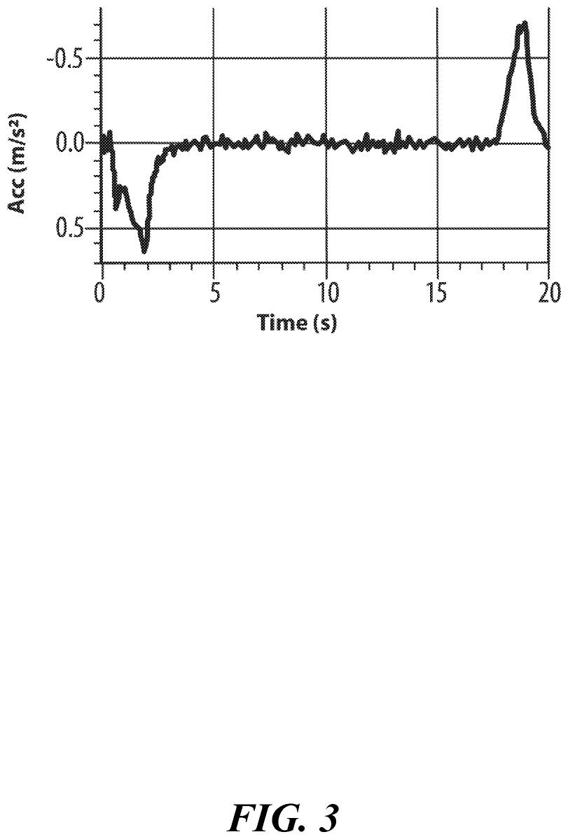

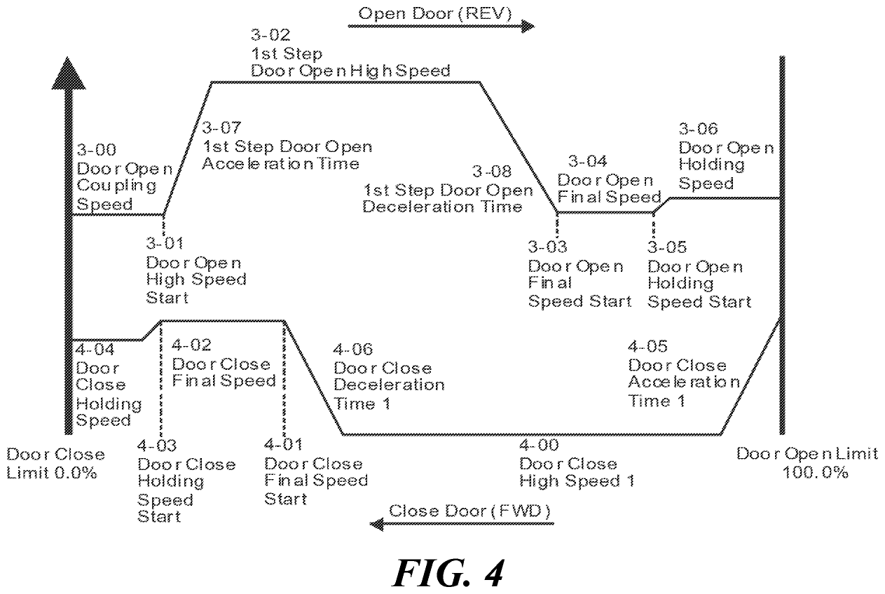

Frequent reference has been made herein to acceleration curves based on accelerometer data. Such curves are per se well known in the art. For example, FIG. 3 depicts the acceleration curve for an elevator carriage as it completes a duty cycle starting at the 3^{rd} floor of a building and ending in the basement. See https://hypertextbook.com/facts/2005/elevator.shtml. FIG. 4 depicts the acceleration curves related to door operations for a Delta VFD-M-D series elevator (see www.delta-americas.com/services/application_detail.aspx?secID=8&pid=0&tid=0CID=02&SID=1&itemID=&ID=779&fid=1&mode=list&hl=en-US (note that the upper curve relates to door opening operations, and the lower curve relates to door closing operations). The systems and methodologies disclosed herein may be readily applied to various elevators to learn the details of such acceleration curves and to apply predictive analytics to the resulting curves for various maintenance purposes.

While the systems, devices and methodologies disclosed herein have been specifically described with respect to their implementation in elevator applications, they are readily extendible to a wide variety of motion control applications in the industrial world. Broadly speaking, the systems described herein apply machine learning to learn the normal (or healthy) operational characteristics of a system at particular points in duty cycles (such as, for example, at a particular point in an acceleration or energy curve), and discern changes in those characteristics which implicate maintenance issues in the host device. Since the system is largely agnostic to the details of the host device or its duty cycles, and works off of the sensor readings (for example, motion (e.g., accelerometer) or energy readings) that give rise to the operational data, the machine learning algorithms may readily detect significant changes or trends in virtually any type of host device whose operation may be characterized by such data.

In a preferred embodiment of the systems and methodologies disclosed herein, all of the motion-related data is obtained with an accelerometer. Based on known parameters of elevators and the initial learning it completes, the monitoring system knows where the elevator currently is on an acceleration curve, and can thus predict where on the acceleration curve the elevator is going to be in the future.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims. It will also be appreciated that the various features set forth in the claims may be presented in various combinations and sub-combinations in future claims without departing from the scope of the invention. In particular, the present disclosure expressly contemplates any such combination or sub-combination that is not known to the prior art, as if such combinations or sub-combinations were expressly written out.

1-20. (canceled)

21. A method for monitoring the operational status of an elevator, comprising:
collecting a first set of operational data from a sensor package installed on the elevator, wherein
the first set of operational data includes motion-related sensor data generated by the sensor package as the elevator progresses through duty cycles while the elevator is in a proper working condition, and
the sensor package includes at least one accelerometer;
training a neural network on the first set of operational data, thereby obtaining a trained neural network;
collecting a second set of operational data from the sensor package, wherein the second set of operational data includes motion-related sensor data generated by the sensor package as the elevator progresses through duty cycles;
analyzing the second set of operational data with the trained neural network to generate a set of analytical results related to the current state of the elevator; and
conveying the set of analytical results for display.

22. The method of claim 21, wherein the first and second sets of operational data relate to at least one parameter selected from the group consisting of acceleration and energy.

23. The method of claim 22, wherein training the neural network comprises training the network to analyze the first or second set of operational data as a function of the current position of the elevator in a duty cycle.

24. The method of claim 23, wherein training the neural network comprises training the network to identify elevator maintenance issues on the basis of the analysis.

25. The method of claim 24, wherein the current position of the elevator in the duty cycle includes the current location of the elevator.

26. The method of claim 24, wherein the current position of the elevator in the duty cycle includes the current task being performed by the elevator.

27. The method of claim 24, wherein the current position of the elevator in the duty cycle includes current location and velocity of the elevator.

28. The method of claim 24, wherein the elevator includes at least one door, wherein the current position of the elevator in the duty cycle includes the current status of the at least one door.

29. The method of claim 24, wherein the current status of the at least one door includes (a) the degree to which the at least one door is opened or closed, or (b) the position of the door in a door opening or door closing cycle.

30. The method of claim 24, wherein the elevator travels between a plurality of floors in a building, wherein the duty cycle includes an origin and a destination, wherein the origin is the last floor the elevator visited, and wherein the destination is the next floor the elevator has been instructed to visit.

31. The method of claim 21, wherein said neural network is a recurrent neural network (RNN).

32. The method of claim 31, wherein said RNN has a long short-term memory (LSTM) architecture.

33. The method of claim 32, further comprising:
performing at least one debouncing operation with said neural network.

34. A system for monitoring an elevator, the system comprising:
an edge intelligence module comprising a sensor package, including at least one accelerometer, installed on an elevator and a neural network; and
an intelligence and analysis module operably connected to the edge intelligence module, wherein the intelligence and analysis module is configured to collect a first set of operational data from the sensor package, wherein the first set of operational data includes motion-related sensor data generated by the sensor package as the elevator progresses through duty cycles while the elevator is in a proper working condition,
train the neural network on the first set of operational data, thereby obtaining a trained neural network,
collect a second set of operational data from the sensor package, wherein the second set of operational data includes motion-related sensor data generated by the sensor package as the elevator progresses through duty cycles,
analyze the second set of operational data with the trained neural network to generate a set of analytical results related to the current state of the elevator, and
convey the set of analytical results for display.

35. The system of claim 34, wherein:
the system further comprises a data aggregation module configured to aggregate data from the edge intelligence module; and
the intelligence and analysis module is further configured to collect the first and second sets of operation data from the sensor package via the data aggregation module.

36. The system of claim 34, wherein:
the system further comprises a presentation module; and
the intelligence and analysis module is further configured to convey the set of analytical results to the presentation module for display.

37. The system of claim 34, wherein the set of analytical results comprises one or more notifications.
